(19) United States
(12) Patent Application Publication
(10) Pub. No.: US 2015/0034191 A1
(43) Pub. Date: Feb. 5, 2015

(54) BELLOWS VALVE AND DOUBLE VALVE BODY INCORPORATING THE SAME

(71) Applicant: PARKER HANNIFIN CANADA, Grimsby (CA)

(72) Inventor: Peter B. Hutton, Houston, TX (US)

(21) Appl. No.: 14/373,858

(22) PCT Filed: Jan. 24, 2013
(86) PCT No.: PCT/US2013/022981

§ 371 Date: Jul. 22, 2014

Related U.S. Application Data
(60) Provisional application No. 61/590,419, filed on Jan. 25, 2012.

(51) Int. Cl. F16K 27/02; F16K 1/14; F16K 17/168

(52) U.S. Cl. CPC F16K 27/0272; F16K 17/168; F16K 1/14
USPC 137/583; 251/335.3; 137/613

(57) ABSTRACT

Valves for regulating the flow of fluids where high containment of the fluid is required for environmental and/or regulatory compliance. In specific embodiments of the invention, the valve is a bellows valve having other anti-leak safety features, including a metal to metal backseat of the valve stem onto a cartridge and Grafoii™ seals and packing,

### CLAIM OF PRIORITY

Applicant claims priority of U.S. Provisional Patent Application Ser. No. 61/590,419, filed 25 Jan. 2012, the entire disclosure of which is herein incorporated by reference.

### BACKGROUND OF THE INVENTION

(1) Field of the Invention

The invention relates generally to valves and more specifically to valves for regulating the flow of fluids where high containment of the fluid is required for environmental and/or regulatory compliance. In specific embodiments of the invention, the valve is a bellows valve having other anti-leak safety features.

(2) Description of the Related Art

The valve art is known to start, stop and regulate the flow of fluids, including gas, liquid, slurries, and mixtures thereof through conduits designed for conditions of flow of such fluids. Considerations of flow include not only pressure and volume of flow, but also requirements for regulating flow, including complete stopping of flow through conduits by the use of one or more valves.

In certain processes of conveying fluids, there are environmental and/or regulatory requirements that no leakage of the fluid be permitted to escape the conduit conveying such fluid. Such requirements include the requirement that no escape be permitted through the valves associated with the conduit for regulating flow. For the sake of simplicity, such fluids, such as for example, benzene, or chlorine-containing fluids, are hereinafter termed “toxic fluids”, although it should be understood that the purpose of the invention is to prevent escape of all fluids from the valves of the invention, whether or not such fluids being conveyed are considered “toxic” to either the environment or to personnel operating the valve.

### BRIEF SUMMARY OF THE INVENTION

The invention is directed to a valve comprising a valve having a valve stem, and a bellows surrounding at least a portion of the valve stem. In a preferred embodiment the position of attachment of the bellows to the valve stem is adjacent the tip of the valve stem.

in a further preferred embodiment of the invention the valve tip is a ball tip.

In another preferred embodiment of the invention the bellows is arranged so as to be attached to one portion of the valve stem near the tip of the stem, with another portion of the bellows being attachable to a cartridge surrounding the valve stem.

In a particularly preferred embodiment, the backseat of the valve stem is configured and located so as to form a metal to metal seal to act as a secondary safety feature to prevent escape of process fluid in the unlikely event of a bellows rupture.

In the most preferred embodiment, the seal surrounding the valve stem is formed of a leak resistant packing, such as a Grafoil™ packing, to further prevent leakage of the process fluid to the environment.

In a still further embodiment of the invention, the bellows valve is incorporated into a valve body having primary and secondary block valves, each of which are configured to utilize the bellows valve of the invention.

In another embodiment of the invention, a modification of that valve body, in which a bleed valve can be positioned between the primary and secondary block valves is also disclosed.

The invention also includes a process of conveying fluids through a conduit controlled by a valve constructed according to the foregoing description.

These and other embodiments of the invention will be further apparent in view of the accompanying drawings and detailed description of the invention.

### BRIEF DESCRIPTION OF THE DRAWINGS

FIG. 1 is a schematic, cross-sectional view of a preferred embodiment of the bellows valve according to the invention;

FIG. 2 is a schematic, cross-sectional view of the bellows valve of FIG. 1 in the state where the valve is backseated (bellows rupture, full open position) where backseating provides a secondary metal to metal seal;

FIG. 2A is an enlarged schematic view of the backseat section of the valve shown in FIG. 2;

FIG. 3 is a schematic, cross-sectional view of the valve of FIG. 1 in the state where the valve is opened but not backseated (bellows rupture, Grafoil™ packing provides third safety seal) and the valve is still functional;

FIG. 4 is a schematic, perspective view of a valve body incorporating a primary and a secondary block valve, each of which are the bellows valve of the invention, and an optional bleed valve;

FIG. 5 is a schematic, front view, partially cross-sectioned, of the valve body of FIG. 4;

FIG. 6 is a schematic, right side view, of the valve body of FIG. 4;

FIG. 7 is a schematic, recommended layout of the valve body of FIG. 4, if installed horizontally;

FIG. 8 is a schematic representation of a flow diagram of process fluid through the valve body of FIG. 4;

FIG. 9 is a schematic, cross-sectional view of an alternative embodiment of the bellows valve of FIG. 2 in the state where the valve is backseated (bellows rupture, full open position) where backseating provides a secondary metal to metal seal; and,

FIG. 9A is an enlarged schematic view of the backseat section of the valve shown in FIG. 9.

### DETAILED DESCRIPTION OF THE INVENTION

In a preferred embodiment, as shown in FIGS. 4 and 8, a process fluid, such as a toxic fluid, enters the valve body 100 in the direction of arrow A and flows in the direction of the arrows through primary block valve 2 but is directed through a bleed port 3 (controlled by bleed valve 7) into contact with the flow path through the valve body 100. After bleeding off gases and/or contaminants, the process fluid flows through secondary block valve 4 and exits valve body 100 in the direction of arrow B.

A pair of flanges 5, 6, (such as 2 inch, 300 class flanges) can be used for the inlet, and outlet, of the process fluid.

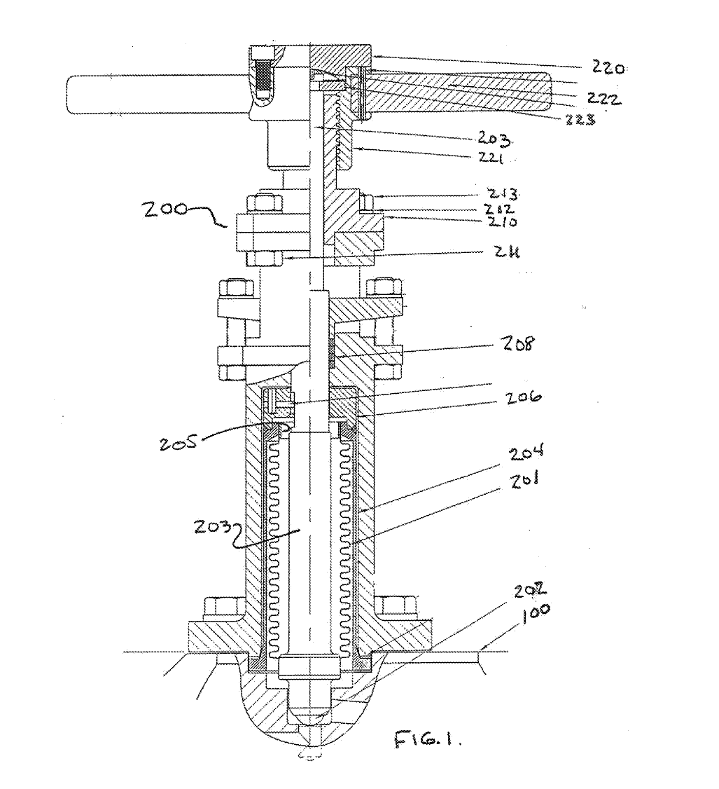

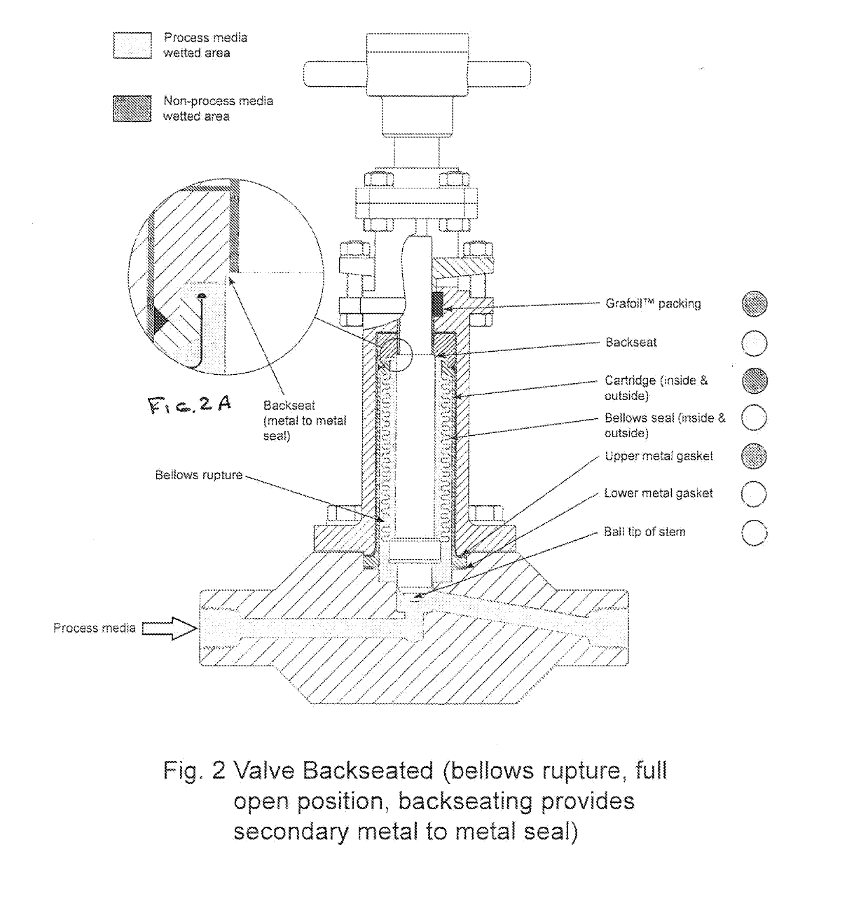

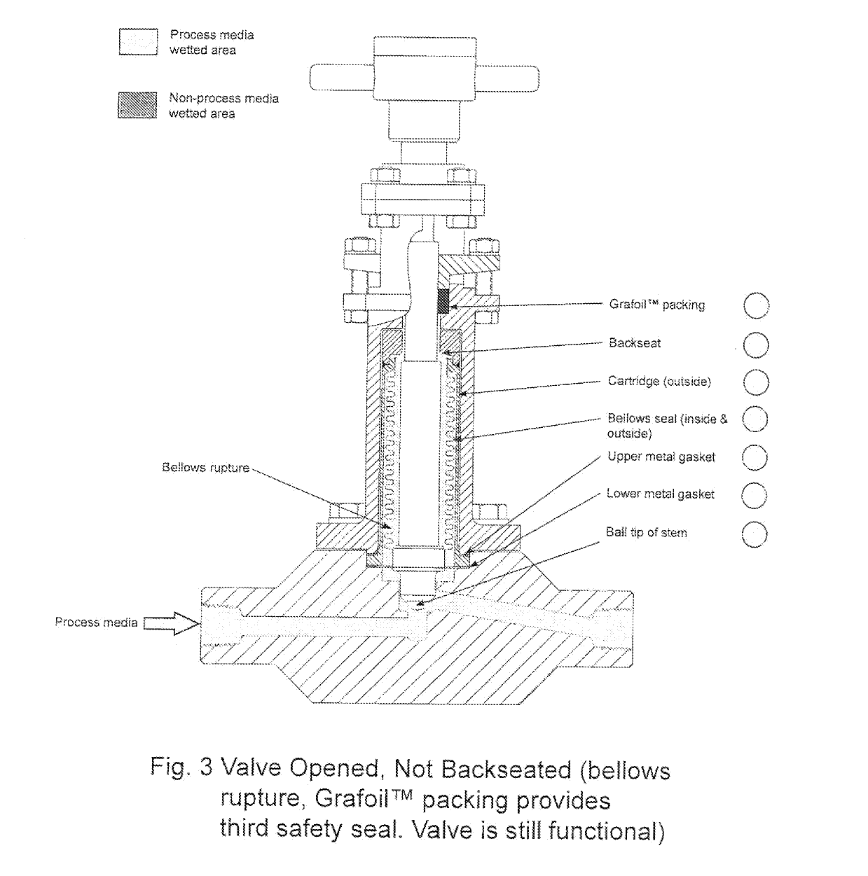

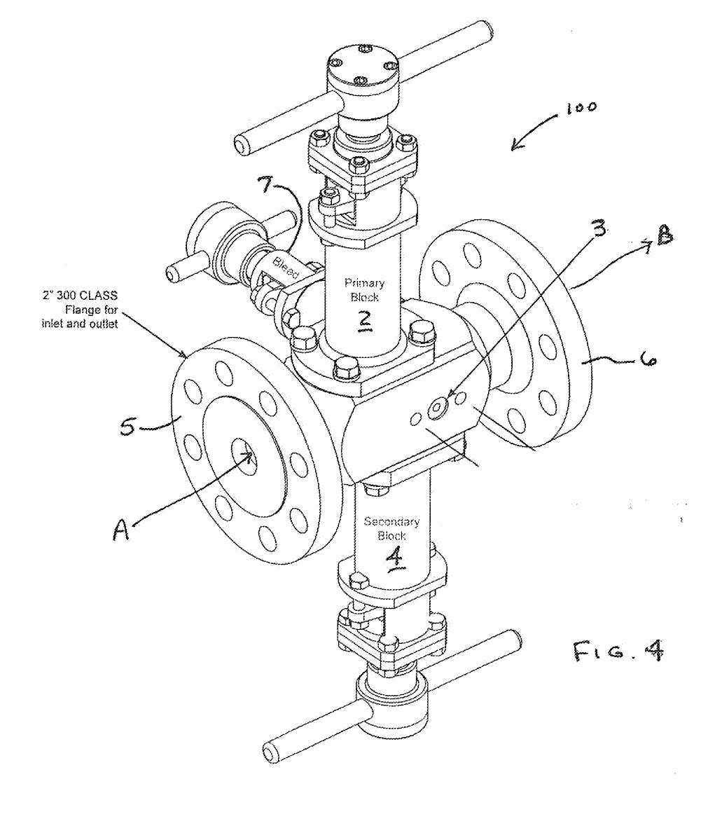

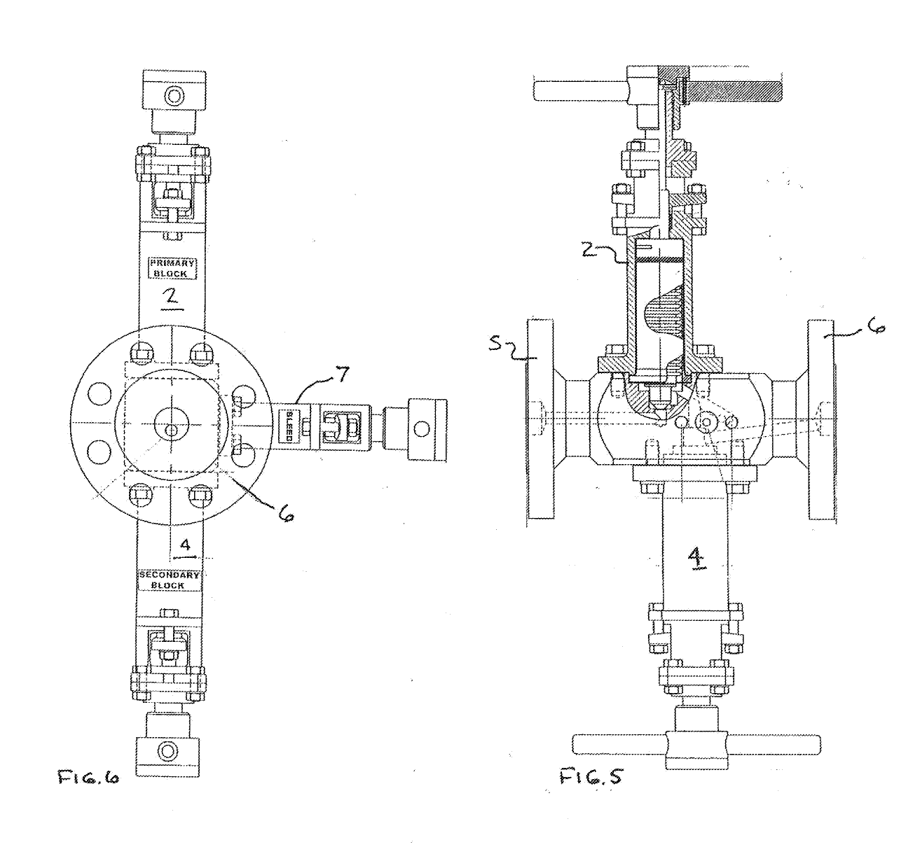

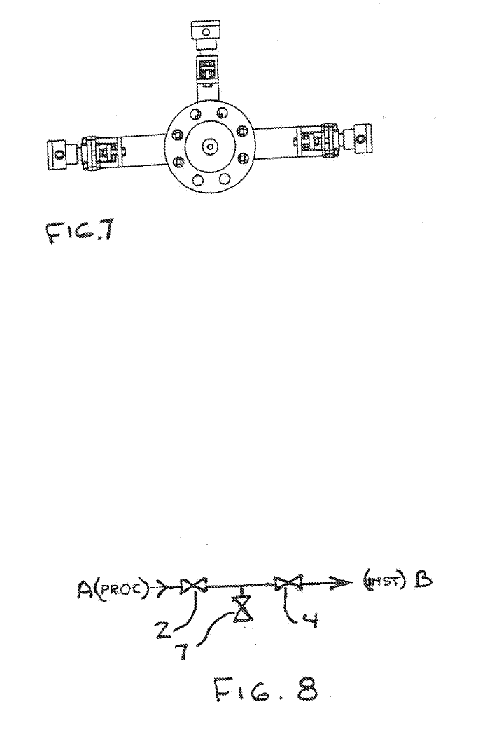

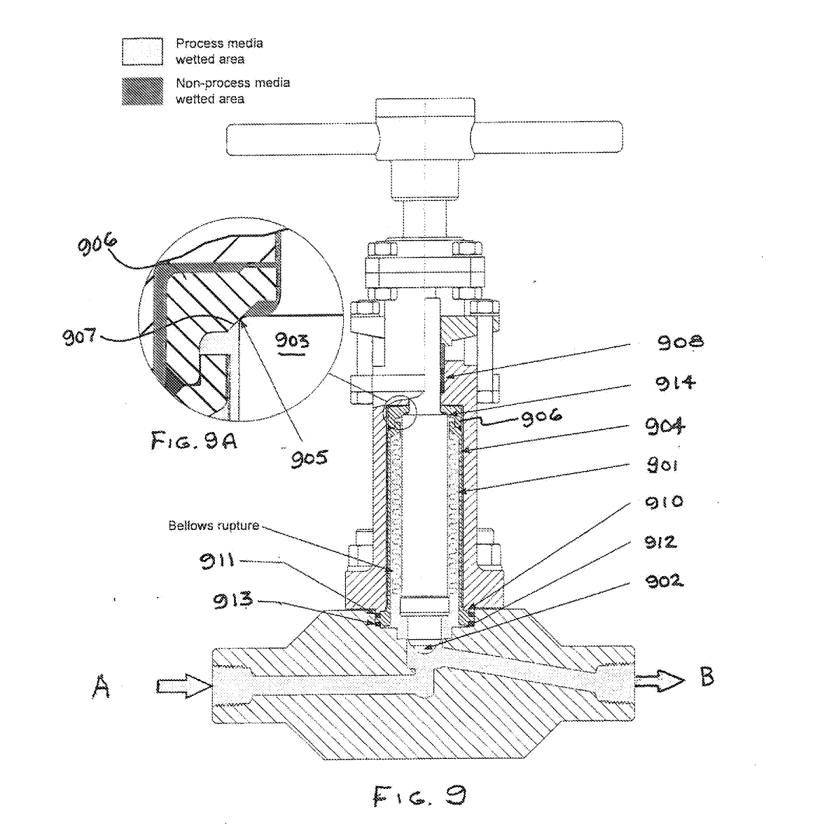

Bellows valve 200 (FIG. 1) can be constructed of any suitable metal. Bellows 201 can be made of a suitable metal, such as Monel. Bellows 201 is attached to valve stem 203, adjacent to valve ball 202. The bellows 201 is surrounded by cartridge 204. The other end of the bellows 201 is preferably connected to cartridge 204 at 205. The valve also contains a cartridge cap 206, upon which a portion of valve stem 203 can be backseated, as discussed below with regard to FIGS. 2 and 2A. The bellows' purpose is to completely isolate the toxic process fluid and prevent any escape up through the valve seals. However, in the unlikely event of rupture of bellows 201, as shown in FIG. 2, the process fluid encounters a secondary safety feature of the invention, when the valve stem 203 is backseated against cartridge cap 206 forming a metal to metal seal containing the process fluid as shown in the enlarged view of FIG. 2A. In the event that the valve stem 203 is not backseated against the cartridge cap 206 when the bellows 201 ruptures, the valve is still operational, as the packing 208, preferably Grafoil™, will prevent escape of the process fluid to the environment.

Other features of the invention, such as the bonnet top 210, attached by bolt 211, washer 212 and nut 213, as is handle cap 220, handle nut 221, handle 222, thrust button 223 and related parts of the valve are for illustrative purposes only and do not form part of the invention, per se.

In the alternate embodiment illustrated in FIGS. 9 and 9A, bellows 901 is attached to valve stem 903, adjacent to valve ball 902. The bellows 901 is surrounded by cartridge 904. The other end of the bellows 901 is preferably connected to cartridge 904 at 905. The valve also contains a cartridge cap 906, upon which a portion of valve stem 903 can be backseated, as discussed below with regard to FIG. 9A. The bellows' purpose is to completely isolate the toxic process fluid and prevent any escape up through the valve seals. However, in the unlikely event of rupture of bellows 901, as shown in FIG. 9, the process fluid encounters a secondary safety feature of the invention, when the valve stem 903 is backseated against cartridge cap 906 forming a metal to metal seal containing the process fluid as shown in the enlarged view of FIG. 9A. This is achieved by structuring a portion of the valve stem, remote from the tip of the valve stem, i.e., the upper portion of the valve stem 903, with an arcuate, preferably radiused shape 905 to assure a reliable metal to metal seal of the valve stem 903 against cartridge cap 906 and reliably backseat the valve stem 903 along its entire perimeter as shown in the enlarged view of FIG. 9A. Cartridge cap 906 can be provided with a suitable shape, such as a chamfer 907, as shown in detail in FIG. 9A. With this structure, backseating 914 along the entire upper perimeter of valve stem 903 is thereby facilitated. Similar to the embodiment of FIGS. 2 and 2A, upper and lower metal seals 910, 912 can be placed surrounding the ball tip of valve stem 903, together with upper and lowerbackup seals 911, 913. The upper and lower backup seals 911, 913 are also preferably made of Grafoil™, as is the packing 908, which is a third safety feature of the valve to prevent leakage of any process fluid to the environment or exposure of workers to toxic process fluids.

It will be apparent to those skilled in the art, from reading the foregoing description, in conjunction with the appended drawings, that the process and apparatus may be subject to various modifications without departing from the spirit and scope of the appended claims.

I claim:

1. A valve comprising a valve stem surrounded by a bellows, the bellows being connected, on one end, to the valve stem adjacent a tip of the valve stem, and the other end of the bellows to a cartridge surrounding the bellows.

2. The valve of claim 1, further comprising a cartridge cap, wherein a portion of the valve stem, remote from the tip of the valve stem, is configured to be backseated on the cartridge cap forming a safety seal.

3. The valve of claim 2, wherein the backseating forms a metal to metal seal.

4. The valve of claim 1, further comprising a packing about the valve stem remote from the valve tip.

5. The valve of claim 4, wherein the packing is a leak resistant packing.

6. The valve of claim 2, further comprising a packing about the valve stem remote from the valve tip.

7. The valve of claim 6, wherein the backseating forms a metal to metal seal.

8. A valve body comprising a primary block valve and a secondary block valve, wherein each of the primary block valve and the secondary block valves comprise the valve of claim 1.

9. The valve body of claim 9, further comprising a bleed valve.

10. A process of conveying a fluid through a valve body, where the valve body comprises at least one valve according to claim 1.

11. The valve of claim 2, wherein the portion of the valve stem is of arcuate shape.

12. The valve of claim 11, wherein the cartridge cap, upon which the valve stem is backseated, has a chamfered configuration.

13. The valve of claim 11, wherein the arcuate shape is a radius.

14. The valve of claim 12, further comprising a packing about the valve stem remote from the valve tip.

15. The valve body of claim 8, wherein each of the primary and secondary block valves are sealed to the valve body by upper and lower metal seals.

16. The valve body according to claim 15, further comprising a leak resistant backup seal.

17. The valve body of claim 16, further comprising a bleed valve.
